(19) United States
(12) Patent Application Publication
(10) Pub. No.: US 2013/0213121 A1
(43) Pub. Date: Aug. 22, 2013

(54) METHOD AND APPARATUS FOR PRESSURE TESTING A PIPE JOINT

(71) Applicant: Göran Sundholm, Tuusula (FI)

(72) Inventor: Göran Sundholm, Tuusula (FI)

(73) Assignee: MARICAP OY, Vantaa (FI)

(21) Appl. No.: 13/882,518

(22) PCT Filed: Sep. 30, 2011
(86) PCT No.: PCT/FI11/50844

§ 371 Date: Apr. 30, 2013

(30) Foreign Application Priority Data
Nov. 1, 2010 (FI) 20106145

(51) Int. Cl. G01M 3/28

(52) U.S. Cl. CPC G01M 3/2853
USPC 73/49.5

(57) ABSTRACT

Method for testing and/or for pressure testing the tightness of the joints of the transfer piping of a pneumatic pipe transport system for waste, in which method the pipe section to be tested is separated inside the pipe from the other piping and pressure medium is conducted into the section, and leaks and/or the pressure of the pressure medium are monitored on the section of pipe to be tested. In the method a device is taken inside the piping, which device comprises a first wall part (21), which comprises first sealing means (31), and a second wall part (22), which comprises second sealing means (33), in which case the pipe section to be tested, more particularly the point of connection, remains between the first wall part (21) and the second wall part (22), in which case the sealing means (31) of the first wall part are brought to be tighter to the inside surface (14) of the pipe and the sealing means (33) of the second wall part (22) are brought to be tighter to the inside surface (15) of the pipe, and pressure medium is brought into the chamber space (23) bounded by the first wall part (21) and the second wall part (22) as well as by the inside surface of the pipe section, and the pressure or a change of pressure is measured or a possible sealing defect of the pipe section is otherwise indicated.

### BACKGROUND OF THE INVENTION

The object of the invention is a method as defined in the preamble of claim 1.

The object of the invention is also an apparatus according to claim 7.

Bushing joints are generally used for connecting pipes, more particularly plastic pipes, together end-on-end. The point of connection is placed into the bushing, i.e. into the sleeve part, such that the ends of the pipe parts to be connected together are inside the bushing and the bushing is thus around the point of connection extending some distance in the longitudinal direction of the pipes from the point of connection in both directions. The bushing part is provided with thermal resistors or corresponding, in which case when forming the joint electric current is conducted to the resistors, in which case the resistors heat up and a joint forms between the sleeve part and the pipe parts. The type of joint described has the problem, particularly when applied in the joints of the transfer pipings of pneumatic waste-transporting systems, that a gap or sill that is detrimental to the transportation of material can remain between the pipe parts to be connected. In prior-art solutions the bushing can contain a countersurface against which the pipe parts to be connected together should be placed, but in practical installation conditions installation errors that result in an unsatisfactory joint can remain in the placement of the pipes into the bushing. Thermoplastic pipe joints of the type described above are described e.g. in the publications U.S. Pat. No. 2,739,829, U.S. Pat. No. 4,530,521 and U.S. Pat. No. 4,906,313. The verification of the tightness of a joint and its pressure testing, especially the verification of the tightness of pneumatic waste-conveying pipings and the pressure testing of their points of connection, is challenging in cases where the pipelines are long. Owing to long pipe series and typically rather large pipe diameters, pipe diameters typically being 200-500 mm, the pressure testing of pipings for their complete length is time consuming owing to the large volume of the pipelines. In addition, a lot of the liquid or gas to be used in pressure testing is consumed, the pumping of which liquid or gas consumes a lot of energy.

The aim of this invention is to achieve a completely new type of solution for the pressure testing of the joints of the transfer piping of a pneumatic waste-conveying system, by means of which the problems of prior-art solutions can be avoided. One important aim is to achieve a method and an apparatus applicable to testing and pressure testing the tightness of the transfer pipings of pneumatic pipe transporting systems for waste, which is suited to different pipe joints.

### BRIEF DESCRIPTION OF THE INVENTION

The method according to the invention is mainly characterized in that in the method a device is taken inside the piping, which device comprises a first wall part, which comprises first sealing means, and a second wall part, which comprises second sealing means, in which case the pipe section to be tested, more particularly the point of connection, remains between the first wall part and the second wall part, in which case the sealing means of the first wall part are brought to be tighter to the inside surface of the pipe and the sealing means of the second wall part are brought to be tighter to the inside surface of the pipe and pressure medium is brought into the chamber space bounded by the first wall part and the second wall part as well as by the inside surface of the pipe section, and the pressure or a change of pressure is measured or a possible sealing defect of the pipe section is otherwise indicated.

The method according to the invention is also characterized by what is stated in claims 2-6.

The apparatus according to the invention is mainly characterized by what is disclosed in claim 7.

The apparatus according to the invention is also characterized by what is disclosed in claims 8-12.

The solution according to the invention has a number of important advantages. With the method and apparatus according to the invention it is possible to quickly and easily pressure test and test the tightness of sections, more particularly the points of connection, of piping.

Consumption of the pressure medium needed is minimal in relation to if the whole pipeline were filled with pressure medium. By using a pressure-medium operated, preferably flexible, bellows means as a sealing means for the first wall part and/or the second wall part, which bellows means when pressurized expands from a first position to a second position in the radial direction and becomes tighter to the inner surface of the pipe, an inexpensive and extremely effective solution is achieved for separating and sealing a pipe section to be tested or pressure tested. By using pressure-medium channels arranged in the body of the device for bringing the pressure medium to the bellows means that function as sealing means, into the chambers of said bellows means, a well-protected and extremely effective solution is achieved for moving the sealing means. By additionally arranging hose means, with which pressure medium is brought to the device, a transfer solution for pressure medium is achieved that is extremely well suited to installation conditions and testing conditions. By using supporting walls, which are at a distance from each other and are in the transverse direction with respect to the pipe part, in connection with the wall parts, into the space between which supporting walls bellows means functioning as sealing means are arranged, a solution is achieved that protects the sealing means very well, especially when putting the device inside the pipe and when taking it out of the pipe. By using a sleeve part as a bushing in the joint and by using the inspection aperture arranged in said sleeve part, an extremely effective solution is achieved for inspecting the quality of a pipe joint in connection with its formation. Additionally, the aperture can be used as a machining point in forming the aperture needed for the installation of various sensors. A fixing point, such as threads, can be conveniently arranged in connection with the aperture for the fixing of various sensors and measuring devices. The aperture of the sleeve part can be further utilized e.g. for the internal visual inspection of a pipe when an aperture is formed from the aperture of the sleeve part through the wall of the pipe parts. In addition, the aperture of the sleeve part can easily be provided with a plug comprising a counterthread, which is suited to the threads of the protrusion part of the aperture of the sleeve part.

### BRIEF DESCRIPTION OF THE FIGURES

In the following, the invention will be described in more detail by the aid of an example with reference to the attached drawing, wherein

FIG. 1 presents a solution according to an embodiment of the invention, sectioned, in a first position and in connection with a sleeve-type pipe joint,

FIG. 2 presents a solution according to an embodiment of the invention, sectioned, in a second position and in connection with a sleeve-type pipe joint,

FIG. 3 presents a solution according to an embodiment of the invention, sectioned, in a first position and in connection with a pipe joint, and

FIG. 4 presents a solution according to an embodiment of the invention, sectioned, in a second position and in connection with a pipe joint.

### DETAILED DESCRIPTION OF THE INVENTION

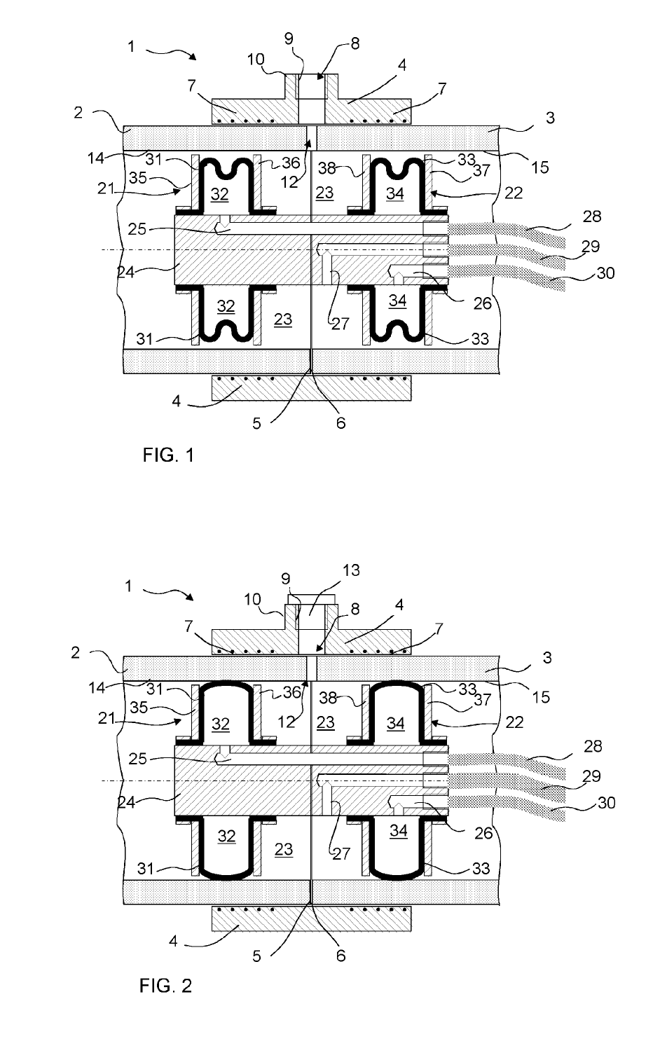

FIGS. 1 and 2 present a sectioned part of a pipe joint 1 applying a sleeve part 4. In the joint two pipe parts 2 and 3 are connected together end-on-end, in which case the butt end 5 of the first pipe part 2 is against the butt end 6 of the second pipe part 3. The butt end sections of the pipe parts 2, 3 are arranged into the bushing, i.e. into the sleeve part 4. The sleeve part 4 comprises heating means 7, such as thermal resistance wires 7, which warm up when electric current is conducted into them. Connection points (not presented) that are per se prior art can be arranged in the sleeve part 4, which connection points are connected to thermal resistance wires and to which connection points electric current is connected. As a consequence of the heating of the heating means 7, typically resistance wires, a joint forms between the sleeve part 4 and the pipe parts 2, 3 in a manner that is per se known in the art. In the joining of thermoplastic pipes this is, per se, prior art. An inspection aperture 8 is formed in the sleeve part 4, which inspection aperture extends through the wall of the sleeve part from the outer surface to the inside surface of the sleeve part. The inspection aperture 8 is arranged essentially at a point at which the opposing butt ends 5, 6 of the pipe parts 2, 3 to be connected together are face-to-face in the finished joint. In the embodiments of the figure a protrusion part 10 is arranged around the inspection aperture 8. According to one embodiment the protrusion part extends a distance from the inspection aperture 8 in the radial direction away from the aperture and outwards from the mainly cylindrical outer surface of the sleeve part. A fixing means, such as a threaded section 9, is arranged in connection with the inspection aperture. The threaded section can be an internally threaded section arranged in the wall of the aperture or an externally threaded section arranged in the protrusion part. The inspection aperture 8 can be provided with a plug 13 (presented in FIG. 2). The plug 13 can be fixed with counterparts, such as with counterthreads, to the fixing means of the aperture, such as to the threaded section 9.

The inspection aperture 8 can be used most preferably in the phase of forming the pipe joint to ensure the correct positioning of the pipe parts 2, 3 to be connected together, for forming a joint of good quality. From the inspection aperture 8 it can easily be detected whether there is an undesirable gap between the pipes, incorrect positioning or whether the pipes are not properly against each other. Thus by means of the invention the correctness of the position of the pipes to be connected can be verified before forming a joint.

From the aperture 8 of the sleeve part of FIG. 1 an aperture 12 through the walls of the pipe parts 2, 3 can be further formed into the channel space of the pipe. The aperture 12 is formed only after the forming of the joint. This second aperture 12 can be used e.g. for measuring pressure or temperature. A measuring sensor can be disposed in the aperture 12 or at least in medium connection with the aperture 12. A measuring sensor or other measuring means can be fixed into the sleeve 4, into the fixing means 9 of the protrusion part 10 of the aperture 8 of the sleeve, by the aid of a suitable counterpart. The aperture 12 can also be used in connection with the pressure testing of the point of connection, e.g. to bring pressure medium, when a pipe means or hose means is connected to it for conducting the pressure medium.

In FIG. 1 a device according to one embodiment of the invention for pressure testing the joint of a pipe is arranged inside a pipe. The device comprises a first wall part 21 and a second wall part 22 as well as a body part 24. The first wall part 21 and the second wall part 22 are arranged on a body part 24 at a distance from each other, in which case a space 23 forms between the wall parts 21, 22. The first wall part comprises sealing means 31, which have a first position, in which case the first wall part 21 has a first diameter, which is smaller than the internal diameter of the pipe part 2, and the sealing means have a second position, in which case the first wall part 21 is larger in its diameter and tightly against the inside surface 14 of the pipe part 2. Correspondingly, the second wall part 22 comprises sealing means 33, which have a first position, in which case the second wall part 22 has a first diameter, which is smaller than the internal diameter of the pipe part 3, and the sealing means 33 have a second position, in which case the second wall part 22 is larger than the first position in its diameter and is tightly against the inside surface 15 of the pipe part 3.

In FIG. 1 the sealing means 31 of the first wall part and the sealing means 33 of the second wall part are in a first position. In this case the device according to the embodiment can be placed into a pipe, inside it, to the point of connection or to the point to be pressure tested. According to the embodiment of FIG. 1, the first wall part 21 is on the first pipe part 2 side of the point of connection and the second wall part 22 is on the second wall part 3 side of the point of connection, i.e. the wall parts 21, 22 are on different sides of the point of connection 5, 6.

The device according to the embodiment of the invention comprises pressure-medium operated sealing means 31, 33 in the first wall part 21 and in the second wall part 22. A first pressure-medium pathway 25 from the pipe means or hose means 28 to the sealing means 31 of the first wall 21 is formed in the body 24 of the device. According to one embodiment the sealing means 31 of the first wall is a flexible bellows means, when conducting pressure medium into the chamber 32 of which the diameter of the bellows means increases and it becomes tighter against the inside surface 14 of the pipe part 2. Correspondingly, a second pressure-medium pathway 26 from the pipe means or hose means 30 to the sealing means 33 of the second wall 22 is formed in the body 24 of the device. The sealing means 33 of the second wall is a flexible bellows means, when conducting pressure medium into the chamber 34 of which the diameter of the bellows means increases and it becomes tighter against the inside surface 15 of the pipe part 3.

The structure of the sealing means 31, 33 is such that they return from the second position into the first position when the pressure medium is removed from the chamber 32, 34.

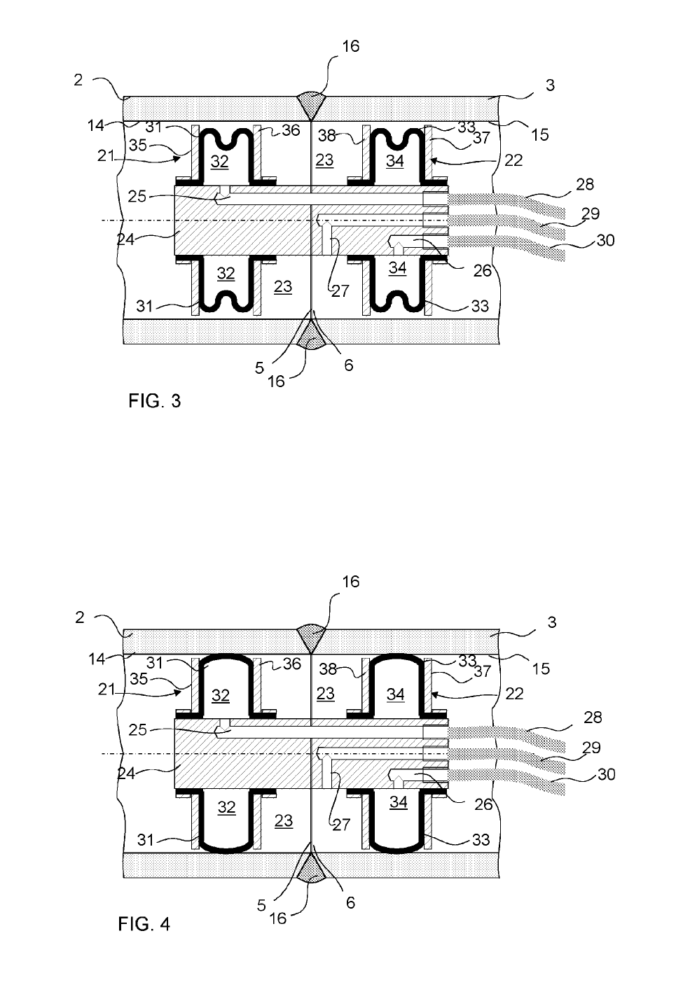

In connection with the first wall part 21 at a distance from each other are supporting walls 35, 36 in the transverse direction of the pipe part, into the space between which supporting walls a bellows means is arranged. The diameter of the supporting walls 35, 36 is to some extent smaller than the internal diameter of the pipe part 2. The bellows means in the first position, in the retracted position, is to some extent closer in the radial direction than the outer edges of the supporting walls to the body 24 of the device. In this case the outer edges of the supporting walls 35, 36 extend to closer to the inside surface of the pipe than bellows means. Here, in the first position (FIG. 1, FIG. 3) of the bellows means the device is easy to arrange inside the pipe part and to extract therefrom without the sealing means 31, 33 hampering the placing of the device into its position.

In connection with the second wall part 22 at a distance from each other are supporting walls 37, 38 in the transverse direction of the pipe part, into the space between which supporting walls a bellows means is arranged. The diameter of the supporting walls 37, 38 is to some extent smaller than the internal diameter of the pipe part 3. The bellows means in the first position, in the retracted position, is to some extent closer in the radial direction than the outer edges of the supporting walls to the body 24 of the device. In this case the outer edges of the supporting walls 37, 38 extend to closer to the inside surface of the pipe than bellows means. Here, in the first position (FIG. 1, FIG. 3) of the bellows means the device is easy to arrange inside the pipe part and to extract therefrom without the sealing means 31, 33 hampering the placing of the device into its position.

In FIGS. 1 and 3 it is seen that the sealing surface of the sealing means contains a fold, which is intended to facilitate the compaction needed when there is no internal overpressure in the chambers 32, 34 of the sealing means.

According to the embodiment of the invention, a third pathway for medium is arranged in the body 24 of the device, which pathway leads from the input pipe or input hose 29 to the space 23 between the first wall part 21 and the second wall part 22.

FIG. 2 presents a situation in which the sealing means 33 of the first wall 21 are in the second position, i.e. tightly against the inside surface 14 of the pipe part 2, and correspondingly the sealing means 33 of the second wall part 22 are in the second position, i.e. tightly against the inside surface 15 of the pipe part 3. The sealing means have been moved from the first position to the second position by conducting pressure medium into the chambers 32, 34 of the sealing means via the pathways 25, 26 for the pressure medium. In FIG. 2 there is a chamber space 23 between the first wall part and the second wall part, which chamber space is disposed at a point to be pressure tested or at a point whose tightness is being examined. The point of connection to be examined or pressure tested is therefore at the point of the chamber space 23 that is formed by the walls 21, 22 of said chamber space and by the inside surface of the pipe.

In the embodiment of FIG. 2 the pressure testing can be performed either via the inspection aperture 8 of the sleeve part 4 and the aperture 12 formed in the wall of the pipe by connecting a pressure-medium line to the protrusion part 10, to the threaded part. Alternatively the inspection aperture of the sleeve part 4 can be provided with a plug 13, in which case pressure testing is performed via the third pressure-medium pathway 27 of the device according to the embodiment of the invention, which pathway leads from the input pipe or input hose 29 into the space 23 between the first wall part 21 and the second wall part 22, which is now tight in respect of the sealing means of the walls 21, 22 and the inside surfaces 14, 15 of the pipe parts.

FIGS. 3 and 4 present a second embodiment in which the joint of the pipe parts 2, 3 has been formed by connecting the joint faces 5, 6 together, e.g. by welding or by otherwise connecting. The joint seam is presented in FIGS. 3 and 4 with the reference number 16. In the embodiment of FIGS. 3 and 4 pressure-testing medium is fed along the pathway 27 for the pressure medium, to which pathway a hose means 29 has been connected.

The pipe joint according to the invention, and the pressure-testing method and pressure-testing device for it, are very well suited for use in connection with the joints of the transfer piping of pneumatic pipe transport systems for waste. The pipe sizes can be rather large in diameter, e.g. typically 200-500 mm.

The object of the invention is thus a method for testing and/or for pressure testing the tightness of the joints of the transfer piping of a pneumatic pipe transport system for waste, in which method the pipe section to be tested is separated inside the pipe from the other piping and pressure medium is conducted into the section, and leaks and/or the pressure of the pressure medium are monitored on the section of pipe to be tested. In the method a device is taken inside the piping, which device comprises a first wall part 21, which comprises first sealing means 31, and a second wall part 22, which comprises second sealing means 33, in which case the pipe section to be tested, more particularly the point of connection, remains between the first wall part 21 and the second wall part 22, in which case the sealing means 31 of the first wall part are brought to be tighter to the inside surface 14 of the pipe and the sealing means 33 of the second wall part 22 are brought to be tighter to the inside surface 15 of the pipe and pressure medium is brought into the chamber space 23 bounded by the first wall part 21 and the second wall part 22 as well as by the inside surface of the pipe section, and the pressure or a change of pressure is measured or a possible sealing defect of the pipe section is otherwise indicated.

According to one embodiment the sealing means 31, 33 of the first wall part and/or of the second wall part is a pressure-medium operated bellows means, which when pressurized expands from a first position to a second position in the radial direction and becomes tighter to the inner surface of the pipe.

According to one embodiment pressure medium is brought into the chamber space 23 from an aperture 12 formed in the wall of the pipe

According to one embodiment pressure medium is brought into the chamber space 23 via a pressure-medium channel 27 arranged in the body 24 of the device.

According to one embodiment pressure medium is brought into the bellows means that function as sealing means 31, 33 via pressure-medium channels 28, 29 arranged in the body 24 of the device.

According to one embodiment the pipe joint to be tested is formed by using a sleeve part 4, which comprises a chamber space, into which the opposing butt ends 5, 6 of the pipe parts 2, 3 to be connected together are placed essentially against each other such that the sleeve part 4 extends a distance from the point of connection of the pipe parts 2,3 to be connected together on top of both pipe parts 2, 3, which sleeve part 4 comprises heating means 7, such as resistance wires 7, as a consequence of the heating of which resistance wires a joint forms between the sleeve part 4 and the pipe parts 2, 3, and that an inspection aperture 8 is formed in the sleeve part 4 through the wall of the sleeve part from the outside to the inside at point in which the positioning of the butt end surfaces 5, 6 placed essentially against each other of the pipe parts 2, 3 to be connected together can be verified and that the inspection aperture 8 is fitted for the purpose of a pressure-medium hose or a measuring sensor, such as a temperature sensor or a pressure measuring sensor.

The object of the invention is also an apparatus for testing and/or for pressure testing the tightness of the joints of the transfer piping of a pneumatic pipe transport system for waste. The device is fitted to be inserted into and extracted from the piping, which device comprises a first wall part 21, which comprises first sealing means 31, and a second wall part 22, which comprises second sealing means 33, in which case the pipe section to be tested, more particularly the point of connection, remains between the first wall part 21 and the second wall part 22, in which case the device comprises means for bringing the sealing means 31 of the first wall part to be tighter to the inside surface 14 of the pipe and means for bringing the sealing means 33 of the second wall part 22 to be tighter to the inside surface 15 of the pipe, and means for bringing pressure medium into the chamber space 23 bounded by the first wall part 21 and the second wall part 22 as well as by the inside surface of the pipe section, and means for measuring the pressure or a change in pressure of the chamber space 23, or for indicating in some other manner a possible sealing defect of the pipe section.

According to one embodiment the sealing means 31, 33 of the first wall part 21 and/or of the second wall part 22 is a pressure-medium operated bellows means, which when pressurized expands from a first position to a second position in the radial direction and becomes tighter to the inner surface of the pipe.

According to one embodiment the device comprises pressure-medium channels 28, 29 arranged in the body 24 of the device for bringing pressure medium to the bellows means that function as sealing means 31, 33, into the chambers 32, 34 of said bellows means.

According to one embodiment a pressure-medium channel 27 is arranged in the body 24 of the device for bringing pressure medium into the chamber space 23.

According to one embodiment pressure medium is brought into the chamber space 23 from an aperture 12 formed in the wall of the pipe.

According to one embodiment in connection with the wall part 21, 22 at a distance from each other are supporting walls 35, 36; 37, 38 in the transverse direction of the pipe part, into the space between which supporting walls a bellows means functioning as a sealing means 31, 33 is arranged.

It is obvious to the person skilled in the art that the invention is not limited to the embodiments presented above, but that it can be varied within the scope of the claims presented below. The characteristic features possibly presented in the description in conjunction with other characteristic features can, if necessary, also be used separately to each other.

1. Method for testing and/or for pressure testing the tightness of the joints of the transfer piping of a pneumatic pipe transport system for wastes, wherein a pipe section to be tested is separated inside the pipe from the other piping and pressure medium is conducted into the section wherein leaks and/or a pressure of the pressure medium are monitored on the section of pipe to be tested comprising the following steps:
positioning a device inside the piping, said device comprises a first wall part (21), including a first sealing means (31), and a second wall part (22), including a second sealing means (33), wherein the pipe section to be tested, more particularly the point of connection, remains between the first wall part (21) and the second wall part (22);
bringing the sealing means (31) of the first wall part to be tighter to the inside surface (14) of the pipe; and
bringing the sealing means (33) of the second wall part (22) to be tighter to the inside surface (15) of the pipe;
supplying a pressure medium into the chamber space (23) bounded by the first wall part (21) and the second wall part (22) as well as by the inside surface of the pipe section; and
measuring a pressure or a change of pressure or a possible sealing defect of the pipe section is otherwise indicated.

2. Method according to claim 1, wherein the sealing means (31, 33) of the first wall part and/or of the second wall part is a pressure-medium operated bellows means, which when pressurized expands from a first position to a second position in the radial direction and becomes tighter to the inner surface of the pipe.

3. Method according to claim 1, wherein pressure medium is brought into the chamber space (23) from an aperture (12) formed in the wall of the pipe.

4. Method according to claim 1, wherein pressure medium is brought into the chamber space (23) via a pressure-medium channel (27) arranged in the body (24) of the device.

5. Method according to claim 1, wherein pressure medium is brought into the bellows means that function as sealing means (31, 33) via pressure-medium channels (28, 29) arranged in the body (24) of the device.

6. Method according to claim 1, wherein the pipe joint to be tested is formed by using a sleeve part (4), including a chamber space, into which the opposing butt ends (5, 6) of the pipe parts (2, 3) to be connected together are placed essentially against each other such that the sleeve part (4) extends a distance from the point of connection of the pipe parts (2,3) to be connected together on top of both pipe parts (2, 3), which sleeve part (4) comprises heating means (7), such as resistance wires, as a consequence of the heating of which resistance wires a joint forms between the sleeve part (4) and the pipe parts (2, 3), and in that an inspection aperture (8) is formed in the sleeve part (4) through the wall of the sleeve part from the outside to the inside at a point in which the positioning of the butt end surfaces (5, 6) placed essentially against each other of the pipe parts (2, 3) to be connected together can be verified, and in that the inspection aperture (8) is fitted for the purpose of a pressure-medium hose or a measuring sensor, such as a temperature sensor or a pressure measuring sensor.

7. Apparatus for testing and/or for pressure testing the tightness of the joints of the transfer piping of a pneumatic pipe transport system for waste, comprising:
a device is fitted to be inserted into and extracted from the piping, said device including a first wall part (21), having a first sealing means (31), and a second wall part (22), having a second sealing means (33), wherein the pipe section to be tested, more particularly the point of connection, remains between the first wall part (21) and the second wall part (22);
said device includes means for bringing the first sealing means (31) of the first wall part to be tighter to the inside surface (14) of the pipe and means for bringing the second sealing means (33) of the second wall part (22) to be tighter to the inside surface (15) of the pipe, and means for bringing pressure medium into the chamber space (23) bounded by the first wall part (21) and the second wall part (22) as well as by the inside surface of the pipe section, and means for measuring a pressure or a change in pressure of the chamber space (23), or for indicating in some other manner a possible sealing defect of the pipe section.

8. Apparatus according to claim 7, wherein the sealing means (31, 33) of the first wall part (21) and/or of the second wall part (22) is a pressure-medium operated bellows means, which when pressurized expands from a first position to a second position in the radial direction and becomes tighter to the inner surface of the pipe.

9. Apparatus according to claim 7, wherein the device comprises pressure-medium channels (28, 29) arranged in the body (24) of the device for bringing pressure medium to the bellows means that function as sealing means (31, 33), into the chambers (32, 34) of said bellows means.

10. Apparatus according to claim 7, wherein a pressure-medium channel (27) is arranged in the body (24) of the device for bringing pressure medium into the chamber space (23).

11. Apparatus according to claim 7, wherein pressure medium is brought into the chamber space (23) from an aperture (12) formed in the wall of the pipe.

12. Apparatus according to claim 7, wherein in connection with the wall part (21, 22) at a distance from each other are supporting walls (35, 36; 37, 38) in the transverse direction of the pipe part, into the space between which supporting walls a bellows means functioning as a sealing means (31, 33) is arranged.

13. Method according to claim 2, wherein pressure medium is brought into the chamber space (23) from an aperture (12) formed in the wall of the pipe.

14. Method according to claim 2, wherein pressure medium is brought into the chamber space (23) via a pressure-medium channel (27) arranged in the body (24) of the device.

15. Method according to claim 3, wherein pressure medium is brought into the chamber space (23) via a pressure-medium channel (27) arranged in the body (24) of the device.

16. Method according to claim 2, wherein pressure medium is brought into the bellows means that function as sealing means (31, 33) via pressure-medium channels (28, 29) arranged in the body (24) of the device.

17. Method according to claim 3, wherein pressure medium is brought into the bellows means that function as sealing means (31, 33) via pressure-medium channels (28, 29) arranged in the body (24) of the device.

18. Method according to claim 4, wherein pressure medium is brought into the bellows means that function as sealing means (31, 33) via pressure-medium channels (28, 29) arranged in the body (24) of the device.

19. Method according to claim 2, wherein the pipe joint to be tested is formed by using a sleeve part (4), including a chamber space, into which the opposing butt ends (5, 6) of the pipe parts (2, 3) to be connected together are placed essentially against each other such that the sleeve part (4) extends a distance from the point of connection of the pipe parts (2,3) to be connected together on top of both pipe parts (2, 3), which sleeve part (4) comprises heating means (7), such as resistance wires, as a consequence of the heating of which resistance wires a joint forms between the sleeve part (4) and the pipe parts (2, 3), and in that an inspection aperture (8) is formed in the sleeve part (4) through the wall of the sleeve part from the outside to the inside at a point in which the positioning of the butt end surfaces (5, 6) placed essentially against each other of the pipe parts (2, 3) to be connected together can be verified, and in that the inspection aperture (8) is fitted for the purpose of a pressure-medium hose or a measuring sensor, such as a temperature sensor or a pressure measuring sensor.

20. Method according to claim 3, wherein the pipe joint to be tested is formed by using a sleeve part (4), including a chamber space, into which the opposing butt ends (5, 6) of the pipe parts (2, 3) to be connected together are placed essentially against each other such that the sleeve part (4) extends a distance from the point of connection of the pipe parts (2,3) to be connected together on top of both pipe parts (2, 3), which sleeve part (4) comprises heating means (7), such as resistance wires, as a consequence of the heating of which resistance wires a joint forms between the sleeve part (4) and the pipe parts (2, 3), and in that an inspection aperture (8) is formed in the sleeve part (4) through the wall of the sleeve part from the outside to the inside at a point in which the positioning of the butt end surfaces (5, 6) placed essentially against each other of the pipe parts (2, 3) to be connected together can be verified, and in that the inspection aperture (8) is fitted for the purpose of a pressure-medium hose or a measuring sensor, such as a temperature sensor or a pressure measuring sensor.
